(19) United States
(12) Patent Application Publication
(10) Pub. No.: US 2015/0339031 A1
(43) Pub. Date: Nov. 26, 2015

(54) CONTEXT-BASED VEHICLE USER INTERFACE RECONFIGURATION

(71) Applicants: Mark L. ZEINSTRA, Holland, MI (US); Scott A. HANSEN, Holland, MI (US); JOHNSON CONTROLS TECHNOLOGY COMPANY, Holland, MI (US)

(72) Inventors: Mark L. Zeinstra, Holland, MI (US); Scott A. Hansen, Holland, MI (US)

(73) Assignee: Johnson Controls Technology Company, Holland, MI (US)

(21) Appl. No.: 14/759,045

(22) PCT Filed: Jan. 2, 2014
(86) PCT No.: PCT/US2014/010078

§ 371 Date: Jul. 2, 2015

Related U.S. Application Data
(60) Provisional application No. 61/749,157, filed on Jan. 4, 2013.

(51) Int. Cl. G06F 3/0481; G06F 3/0482; G06F 3/0484; H04L 29/08

(52) U.S. Cl. CPC G06F 3/04817; H04L 67/125; G06F 3/0482; G06F 3/04842

(57) ABSTRACT

A method for contextually reconfiguring a user interface in a vehicle includes receiving context information for the vehicle, determining a vehicle context including at least one of a location of the vehicle and a condition of the vehicle based on the context information, determining one or more control options based on the vehicle context, and causing the user interface to display one or more selectable icons. The icons are displayed in response to the determined vehicle context and selecting an icon initiates one or more of the context-based control options.

### CROSS-REFERENCE TO RELATED PATENT APPLICATIONS

This application claims the benefit of U.S. Provisional Application No. 61/749,157, filed Jan. 4, 2013, which is hereby incorporated by reference in its entirety.

### BACKGROUND

Many vehicles include an electronic display screen for presenting applications relating to functions such as vehicle navigation and audio systems control. Traditional user interfaces presented on such electronic display screens can be complex and typically require several user input commands to select an appropriate control action or to launch a frequently used application. It is challenging and difficult to develop vehicle user interface systems. Improved vehicle user interface systems and methods are needed.

### SUMMARY

One implementation of the present disclosure is a method for contextually reconfiguring a user interface in a vehicle. The method includes establishing a communications link with a remote system when the vehicle enters a communications range with respect to the remote system, determining one or more options for interacting with the remote system, and displaying one or more selectable icons on a touch-sensitive display screen in response to the vehicle entering the communications range. Selecting a displayed icon may initiate one or more of the options for interacting with the remote system. In some embodiments, the remote system is a home control system including at least one of a garage door system, a gate control system, a lighting system, a security system, and a temperature control system, wherein the options for interacting with the remote system are options for controlling the home control system.

In some embodiments, the method further includes receiving status information from the remote system, wherein the status information includes information relating to a current state of the remote system, and causing the user interface to display the status information in conjunction with the one or more of the selectable icons. In some embodiments, at least one of the selectable icons includes information relating to a previous control action taken with respect to the remote system.

In some embodiments, the remote system is a system for controlling a garage door and at least one of the selectable icons is a garage door control icon. In such embodiments, the method may further include displaying an animation sequence indicating that the garage door is opening or closing, wherein the animation sequence is displayed in response to a user selecting the garage door control icon. In some embodiments, an animation sequence is displayed on a primary display screen and the selectable icons are displayed on a secondary display screen.

Another implementation of the present disclosure is a second method for contextually reconfiguring a user interface in a vehicle. The second method includes receiving context information for the vehicle, determining a vehicle context based on the context information including at least one of a location of the vehicle and a condition of the vehicle, determining one or more control options based on the vehicle context, and causing the user interface to display one or more selectable icons. The icons may be displayed in response to the determined vehicle context and selecting an icon may initiate one or more of the context-based control options. In some embodiments, the vehicle includes a primary display screen and a secondary display screen and only the selectable icons are displayed on the secondary display screen.

In some embodiments, the vehicle context is a location of the vehicle and the second method further includes determining that the vehicle is within a communications range with respect to a remote system based on the location of the vehicle and establishing a communications link with the remote system.

In some embodiments, the vehicle context is a condition of the vehicle including at least one of a low fuel indication, an accident indication, a vehicle speed indication, and a vehicle activity indication. When the condition is a low fuel indication, selection of at least one of the icons may initiate a process for locating nearby fueling stations when the icon is selected. When the condition is an emergency indication, selection of at least one of the icons may initiate a process for obtaining emergency assistance when the icon is selected.

Another implementation of the present disclosure is a system for providing a user interface in a vehicle. The system includes a primary display screen, a secondary display screen, and a processing circuit coupled to the primary and secondary display screens. The secondary display screen may be a touch-sensitive display and the processing circuit may be configured to receive user input via the secondary display screen and to present a user interface on the primary display screen in response to the user input received via the secondary display screen.

In some embodiments, the processing circuit is configured to cause one or more selectable icons to be displayed on the secondary display screen and the user input received via the secondary display screen includes selecting one of more of the icons. In some embodiments, only the selectable icons are displayed on the secondary display screen. In some embodiments, the user interface presented on the primary display screen allows user interaction with one or more vehicle systems. The vehicle systems may include at least one of a navigation system, an audio system, a temperature control system, a communications system, and an entertainment system.

In some embodiments, the user input received via the secondary display screen launches an application presented on the primary display screen. In some embodiments, the user input received via the secondary display screen launches an application and a user interface for interacting with the launched application is presented exclusively on one or more user interface devices other than the secondary display screen.

Another implementation of the present disclosure is a method for providing a user interface in a vehicle. The method includes providing a primary display screen and a secondary touch-sensitive display screen, displaying one or more selectable icons on the secondary display screen, receiving a user input selecting one or more of the selectable icons via the secondary display screen, and presenting a user interface on the primary display screen in response to the user input received via the secondary display screen. In some embodiments, only the selectable icons are displayed on the secondary display screen. In some embodiments, the user interface presented on the primary display screen allows user interaction with one or more vehicle systems including at least one of a navigation system, an audio system, a temperature control system, a communications system, and an entertainment system.

In some embodiments, the user input received via the secondary display screen launches an application presented exclusively on the primary display screen. In some embodiments, the user input received via the secondary display screen launches an application and user interface for interacting with the launched application is presented exclusively on one or more user interface devices other than the secondary display screen.

Another implementation of the present disclosure is a system for providing a user interface in a vehicle. The system includes a touch-sensitive display screen, a mobile device interface, and a processing circuit coupled to the touch-sensitive display screen and the mobile device interface. The processing circuit may be configured to receive a user input via the touch-sensitive display screen and to launch an application on a mobile device connected via the mobile device interface in response to the user input.

In some embodiments, a user interface for interacting with the launched application is presented exclusively on one or more user interface devices other than the touch-sensitive display screen. In some embodiments, the mobile device is at least one of cell phone, a tablet, a data storage device, a navigation device, and a portable media device.

In some embodiments, the processing circuit is configured to cause one or more selectable icons to be displayed on the touch-sensitive display screen and the user input received via the touch-sensitive display screen includes selecting one of more of the icons. In some embodiments, the processing circuit is configured to receive a notification from the mobile device and cause the notification to be displayed on the touch-sensitive display screen.

### BRIEF DESCRIPTION OF THE DRAWINGS

FIG. 1 is a drawing of an interior of a vehicle illustrating a primary display screen and a secondary display screen, according to an exemplary embodiment.

FIG. 2 is a block diagram of a control system for configuring a user interface presented on the primary display and the secondary display, according to an exemplary embodiment.

FIG. 3 is a drawing of various icons including settings icons, home control icons, radio icons, application icons, audio device icons, and emergency icons presented on the secondary display screen, according to an exemplary embodiment.

FIG. 4 is a drawing showing the settings icons in greater detail including a “show all” icon, an “active context” icon, and a “favorites” icon, according to an exemplary embodiment.

FIG. 5 is a drawing illustrating a user interface for displaying a group of favorite icons visible when the “favorites” icon of FIG. 4 is selected, according to an exemplary embodiment.

FIG. 6 is a drawing illustrating a user interface for removing icons from the group of favorite icons shown in FIG. 5, according to an exemplary embodiment.

FIG. 7 is a drawing illustrating a modified group of favorite icons after removing multiple icons from the favorite group using the user interface shown in FIG. 6, according to an exemplary embodiment.

FIG. 8 is a drawing illustrating a user interface for adding icons to the group of favorite icons shown in FIG. 5, according to an exemplary embodiment.

FIG. 9 is a drawing of an interface for viewing all available icons visible after the “show all” icon of FIG. 4 is selected, showing icons included in the group of favorite icons with identifying markings, according to an exemplary embodiment.

FIG. 10 is a drawing showing the home control icons in greater detail including a garage door control icon, an untrained icon, and a MyQ® icon, according to an exemplary embodiment.

FIG. 11A is a drawing of a user interface presented on the primary display screen after selecting the garage door control icon of FIG. 10, illustrating a status graphic indicating that the garage door is currently opening, according to an exemplary embodiment.

FIG. 11B is a drawing of the user interface of FIG. 11A illustrating a status graphic indicating that the garage door is currently closing, according to an exemplary embodiment.

FIG. 11C is a drawing of the user interface of FIG. 11A illustrating a status graphic indicating that the garage door is currently closed, according to an exemplary embodiment.

FIG. 11D is a drawing of the user interface of FIG. 11A illustrating a status graphic indicating that the garage door is currently closed and the time at which the garage door was closed, according to an exemplary embodiment.

FIG. 12 is a drawing of a user interface presented on the secondary display screen showing a currently active remote system status and a time at which the remote system transitioned into the currently active status, according to an exemplary embodiment.

FIG. 13 is a drawing of the emergency icons in greater detail including a “911” icon, a hazard icon, and an insurance icon, according to an exemplary embodiment.

FIG. 14 is a flowchart illustrating a process for dynamically reconfiguring a user interface in a vehicle upon entering a communications range with respect to a remote system, according to an exemplary embodiment.

FIG. 15 is a flowchart illustrating a process for contextually reconfiguring a user interface in a vehicle based on a current vehicle condition or location, according to an exemplary embodiment.

FIG. 16 is a flowchart illustrating a process for reconfiguring a user interface presented on a primary display screen based on user input received via a secondary display screen, according to an exemplary embodiment.

### DETAILED DESCRIPTION

Referring generally to the figures, systems and methods for providing a user interface in a vehicle are shown and described, according to various exemplary embodiments. The systems and methods described herein may be used to reconfigure a user interface provided on one or more visual display devices within the vehicle. The user interface may be dynamically reconfigured based on a vehicle location, a vehicle context, or other information received from a local vehicle system (e.g., navigation system, entertainment system, engine control system, communications system, etc.) or a remote system (e.g., home control, security, lighting, mobile commerce, business-related, etc.).

In some implementations, the user interface may be presented on two or more visual display screens. A primary display screen may be used to present applications (e.g., temperature control, navigation, entertainment, etc.) and provide detailed information and/or options for interacting with one or more local or remote systems. A secondary display screen may be used to launch applications presented on the primary display screen and provide basic control options for interacting with a remote system (e.g., a garage door system, a home control system, etc.). In some implementations, the secondary display screen may be used to launch applications on a mobile device (e.g., cell phone, portable media device, mobile computing device, etc.). The secondary display screen may display notifications received via the mobile device (e.g., messages, voicemail, email, etc.).

Advantageously, the systems and methods of the present disclosure may cause one or more selectable icons to be displayed on the secondary display screen based on a vehicle context (e.g., status information, location information, or other contemporaneous information). The context-based display of icons may provide a user with a convenient and efficient mechanism for initiating appropriate control actions based on the vehicle context. For example, when the vehicle enters communications range with a garage door control system (e.g., for a user's home garage door), a garage door control icon may be displayed on the secondary display screen, thereby allowing the user to operate the garage door. Other vehicle contexts (e.g., low fuel, detected accident, steady speed, etc.) may result in various other appropriate icons being displayed on the secondary display screen. A conveniently located tertiary display screen (e.g., a heads-up display) may be used to indicate one or more active vehicle contexts to a driver of the vehicle.

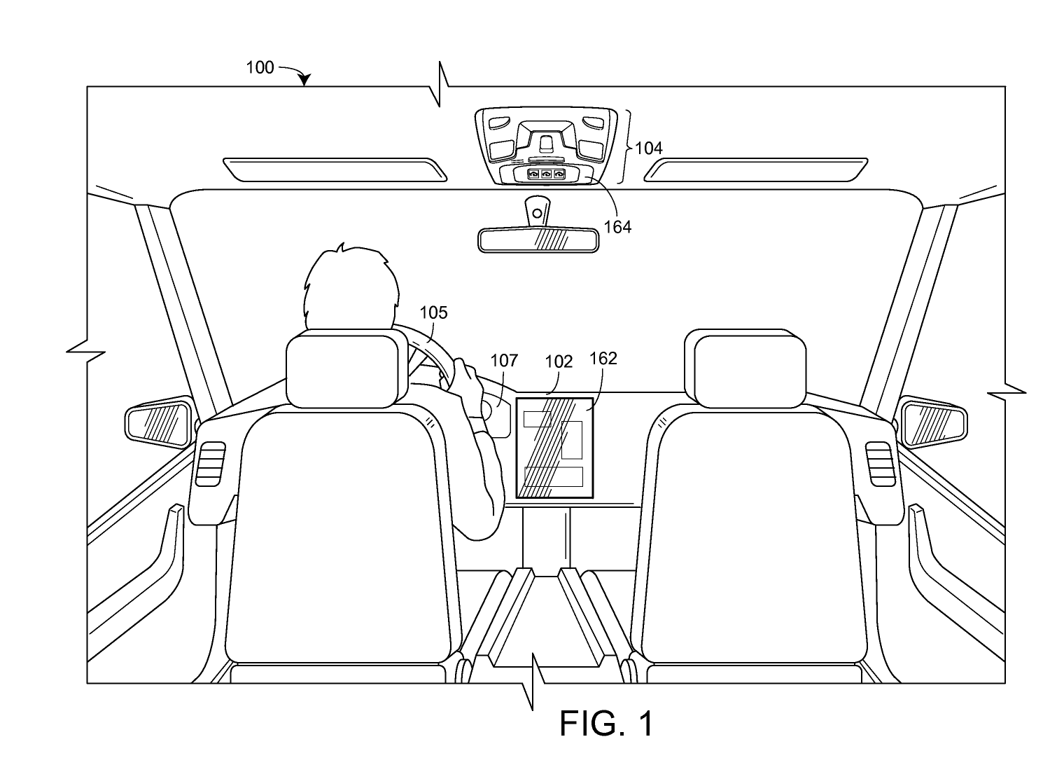

Referring to FIG. 1, an interior of a vehicle 100 is shown, according to an exemplary embodiment. Vehicle 100 is shown to include a primary display 162 and a secondary display 164. Primary display 162 is shown as part of a center console 102 accessible to a user in the driver seat and/or front passenger seat of vehicle 100. In some embodiments, primary display 162 may be positioned adjacent to an instrument panel, a steering wheel 105, or integrated into a dashboard 107 of vehicle 100. In other embodiments, primary display 162 may be located elsewhere within vehicle 100 (e.g., in a headliner, a rear surface of the driver seat or front passenger seat, accessible to passengers in the rear passenger seats, etc.). Secondary display 164 is shown as part of an overhead console 104 above center console 102. Overhead console 104 may contain or support secondary display 164. Secondary display 164 may be located in overhead console 104, steering wheel 105, dashboard 107, or elsewhere within vehicle 100.

Primary display 162 and secondary display 164 may function as user interface devices for presenting visual information and/or receiving user input from one or more users within vehicle 100. In some embodiments, secondary display 164 includes a touch-sensitive display screen. The touch-sensitive display screen may be capable of visually presenting one or more selectable icons and receiving a user input selecting one or more of the presented icons. The selectable icons presented on secondary display 164 may be reconfigured based on an active vehicle context. In some embodiments, primary display 162 and secondary display 164 may be implemented as a single display device. The functions described herein with respect to primary display 162, secondary display 164, a tertiary display, and/or other displays may, in some embodiments, be performed using other displays.

In some embodiments, vehicle 100 includes a tertiary display. The tertiary display may provide an indication of one or more currently active vehicle contexts. Advantageously, the tertiary display may indicate currently active vehicle contexts to a driver of the vehicle while allowing the driver to maintain focus on driving. For example, the tertiary display may indicate the context-specific icons currently presented on secondary display 164 without requiring the driver to direct his or her gaze toward secondary display 164. The tertiary display may be a heads-up display (HUD), an LCD panel, a backlit or LED status indicator, a dashboard light, or any other device capable of presenting visual information. The tertiary display may be located in front of the driver (e.g., a HUD display panel), in dashboard 107, in steering wheel 105, or visible in one or more vehicle mirrors (e.g., rear-view mirror, side mirrors, etc).

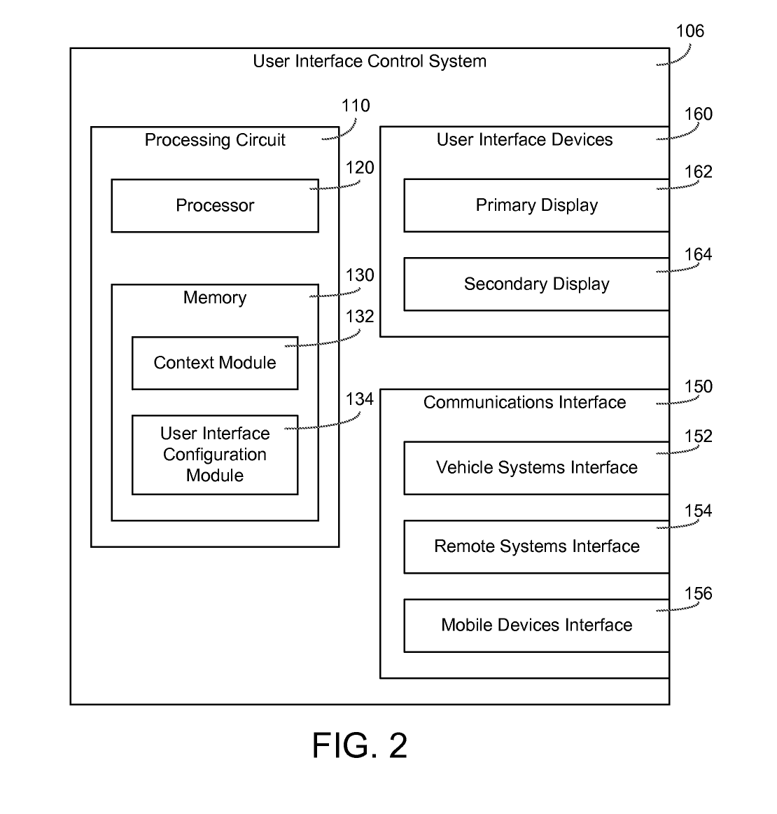

Referring now to FIG. 2, a block diagram of a user interface control system 106 is shown, according to an exemplary embodiment. System 106 may control and/or reconfigure the user interfaces presented on primary display 162 and secondary display 164. Control system 106 is shown to include user interface devices 160, a communications interface 150, and a processing circuit 110 including a processor 120 and memory 130.

User interface devices 160 are shown to include primary display 162 and secondary display 164. Primary display 162 may be used to present applications (e.g., temperature control, navigation, entertainment, etc.) and provide detailed information and/or options for interacting with one or more local or remote systems. In some embodiments, primary display 162 is a touch-sensitive display. For example, primary display 162 may include a touch-sensitive user input device (e.g., capacitive touch, projected capacitive, piezoelectric, etc.) capable of detecting touch-based user input. In other embodiments, primary display 162 is a non-touch-sensitive display. Primary display 162 may include one or more knobs, pushbuttons, and/or tactile user inputs. Primary display 162 may be of any technology (e.g., liquid crystal display (LCD), plasma, thin film transistor (TFT), cathode ray tube (CRT), etc.), configuration (e.g., portrait or landscape), or shape (e.g., polygonal, curved, curvilinear). Primary display 162 may be an embedded display (e.g., a display embedded in control system 106 or other vehicle systems, parts or structures), a standalone display (e.g., a portable display, a display mounted on a movable arm), or a display having any other configuration.

Secondary display 164 may be used to display one or more selectable icons. The icons may be used to launch applications presented on primary display 162. The icons may also provide basic control options for interacting with a remote system (e.g., a home control system, a garage door control system, etc.) or a mobile device (e.g., cell phone, tablet, portable media player, etc.) In some embodiments, secondary display 164 is a touch-sensitive display. Secondary display 164 may include a touch-sensitive user input device (e.g., capacitive touch, projected capacitive, piezoelectric, etc.) capable of detecting touch-based user input. Secondary display 164 may be sized to display several (e.g., two, three, four or more, etc.) selectable icons simultaneously. For embodiments in which secondary display 164 is a touch-sensitive display, an icon may be selected by touching the icon. Alternatively, secondary display 164 may be a non-touch-sensitive display including one or more pushbuttons and/or tactile user inputs for selecting a displayed icon.

Still referring to FIG. 2, system 106 is further shown to include a communications interface 150. Communications interface 150 is shown to include a vehicle systems interface 152, a remote systems interface 154, and a mobile devices interface 156.

Vehicle systems interface 152 may facilitate communication between control system 106 and any number of local vehicle systems. For example, vehicle systems interface 152 may allow control system 106 to communicate with local vehicle systems including a GPS navigation system, an engine control system, a transmission control system, a HVAC system, a fuel system, a timing system, a speed control system, an anti-lock braking system, etc. Vehicle systems interface 152 may be any electronic communications network that interconnects vehicle components.

The vehicle systems connected via interface 152 may receive input from local vehicle sensors (e.g., speed sensors, temperature sensors, pressure sensors, etc.) as well as remote sensors or devices (e.g., GPS satellites, radio towers, etc.). Inputs received by the vehicle systems may be communicated to control system 106 via vehicle systems interface 152. Inputs received via vehicle systems interface 152 may be used to establish a vehicle context (e.g., low fuel, steady state highway speed, currently turning, currently braking, an accident has occurred, etc.) by context module 132. The vehicle context may be used by UI configuration module 134 to select one or more icons to display on secondary display 164.

In some embodiments vehicle systems interface 152 may establish a wired communication link such as with USB technology, IEEE 1394 technology, optical technology, other serial or parallel port technology, or any other suitable wired link. Vehicle systems interface 152 may include any number of hardware interfaces, transceivers, bus controllers, hardware controllers, and/or software controllers configured to control or facilitate the communication activities of the local vehicle systems. For example, vehicle systems interface 152 may be a local interconnect network, a controller area network, a CAN bus, a LIN bus, a FlexRay bus, a Media Oriented System Transport, a Keyword Protocol 2000 bus, a serial bus, a parallel bus, a Vehicle Area Network, a DC-BUS, a IDB-1394 bus, a SMARTwireX bus, a MOST bus, a GA-NET bus, IE bus, etc.

In some embodiments, vehicle systems interface 152 may establish wireless communication links between control system 106 and vehicle systems or hardware components using one or more wireless communications protocols. For example, secondary display 164 may communicate with processing circuit 110 via a wireless communications link. Interface 152 may support communication via a BLUETOOTH communications protocol, an IEEE 802.11 protocol, an IEEE 802.15 protocol, an IEEE 802.16 protocol, a cellular signal, a Shared Wireless Access Protocol-Cord Access (SWAP-CA) protocol, a Wireless USB protocol, an infrared protocol, or any other suitable wireless technology.

Control system 106 may be configured to route information between two or more vehicle systems via interface 152. Control system 106 may route information between vehicle systems and remote systems via vehicle systems interface 152 and remote systems interface 154. Control system 106 may route information between vehicle systems and mobile devices via vehicle systems interface 152 and mobile devices interface 156.

Still referring to FIG. 2, communications interface 150 is shown to include a remote systems interface 154. Remote systems interface 154 may facilitate communications between control system 106 and any number of remote systems. A remote system may be any system or device external to vehicle 100 capable of interacting with control system 106 via remote systems interface 154. Remote systems may include a radio tower, a GPS navigation or other satellite, a cellular communications tower, a wireless router (e.g., WiFi, IEEE 802.11, IEEE 802.15, etc.), a BLUETOOTH® capable remote device, a home control system, a garage door control system, a remote computer system or server with a wireless data connection, or any other remote system capable of communicating wirelessly via remote systems interface 154.

In some embodiments, remote systems may exchange data among themselves via remote systems interface 154. For example, control system 106 may be configured to route information between two or more remote systems via remote systems interface 154. Control system 106 may route information between remote systems and vehicle systems via remote systems interface 154 and vehicle systems interface 152. Control system 106 may route information between remote systems and mobile devices via remote systems interface 154 and mobile devices interface 156.

In some embodiments, remote systems interface 154 may simultaneously connect to multiple remote systems. Interface 154 may send and/or receive one or more data streams, data strings, data files or other types of data between control system 106 and one or more remote systems. In various exemplary embodiments, the data files may include text, numeric data, audio, video, program data, command data, information data, coordinate data, image data, streaming media, or any combination thereof.

Still referring to FIG. 2, communications interface 150 is shown to include a mobile devices interface 156. Mobile devices interface 156 may facilitate communications between control system 106 and any number of mobile devices. A mobile device may be any system or device having sufficient mobility to be transported within vehicle 100. Mobile devices may include a mobile phone, a personal digital assistant (PDA), a portable media player, a personal navigation device (PND), a laptop computer, tablet, or other portable computing device, etc.

In some embodiments, mobile devices interface 156 may establish a wireless communications link via a BLUETOOTH communications protocol, an IEEE 802.11 protocol, an IEEE 802.15 protocol, an IEEE 802.16 protocol, a cellular signal, a Shared Wireless Access Protocol-Cord Access (SWAP-CA) protocol, a Wireless USB protocol, or any other suitable wireless technology. Mobile devices interface 156 may establish a wired communication link such as with USB technology, IEEE 1394 technology, optical technology, other serial or parallel port technology, or any other suitable wired link.

Mobile devices interface 156 may facilitate communication between two or more mobile devices, between mobile devices and remote systems, and/or between mobile devices and vehicle systems. For example, mobile devices interface 156 may permit control system 106 to receive a notification (e.g., of a text message, email, voicemail, etc.) from a cellular phone. The notification may be communicated from control system 106 to user interface devices 160 via vehicle systems interface 152 and presented to a user via a display (e.g., secondary display 164).

Still referring to FIG. 2, system 106 is shown to include a processing circuit 110 including a processor 120 and memory 130. Processor 120 may be implemented as a general purpose processor, an application specific integrated circuit (ASIC), one or more field programmable gate arrays (FPGAs), a CPU, a GPU, a group of processing components, or other suitable electronic processing components.

Memory 130 may include one or more devices (e.g., RAM, ROM, Flash memory, hard disk storage, etc.) for storing data and/or computer code for completing and/or facilitating the various processes, layers, and modules described in the present disclosure. Memory 130 may comprise volatile memory or non-volatile memory. Memory 130 may include database components, object code components, script components, or any other type of information structure for supporting the various activities and information structures described in the present disclosure. According to an exemplary embodiment, memory 130 is communicably connected to processor 120 via processing circuit 110 and includes computer code (e.g., via the modules stored in memory) for executing (e.g., by processing circuit 110 and/or processor 120) one or more processes described herein.

Memory 130 is shown to include a context module 132 and a user interface configuration module 134. Context module 132 may receive input from one or more vehicle systems (e.g., a navigation system, an engine control system, a transmission control system, a fuel system, a timing system, an anti-lock braking system, a speed control system, etc.) via vehicle systems interface 152. Input received from a vehicle system may include measurements from one or more local vehicle sensors (e.g., a fuel level sensor, a braking sensor, a steering or turning sensor, etc.) as well as inputs received by a local vehicle system from a mobile device or remote system. Context module 132 may also receive input directly from one or more remote systems via remote systems interface 154 and from one or more mobile devices via mobile devices interface 156. Input received from a remote system may include GPS coordinates, mobile commerce data, interactivity data from a home control system, traffic data, proximity data, location data, etc. Input received from a mobile device may include text, numeric data, audio, video, program data, command data, information data, coordinate data, image data, streaming media, or any combination thereof

In some embodiments, context module 132 uses the data received via communications interface 150 to establish a vehicle context (e.g., a vehicle state, condition, status, etc.). For example, context module 132 may receive input data from a vehicle fuel system indicating an amount of fuel remaining in vehicle 100. Context module 132 may determine that vehicle 100 is low on fuel based on such data and establish a “low fuel” vehicle context. Context module 132 may receive input from an accident detection system indicating that vehicle 100 has been involved in a collision and establish an “accident” vehicle context. Context module 132 may receive input data from a speed control or speed monitoring system indicating a current speed of vehicle 100. Context module 132 may determine that vehicle 100 is traveling at a steady state highway speed based on such data and establish a “cruising” vehicle context. Context module 132 may receive input from a vehicle system indicating that vehicle 100 is currently turning or that the driver is otherwise busy and establish a “distracted” vehicle context. Any number of vehicle contexts may be determined based on input received via communications interface 150 including contexts not explicitly described. One or more vehicle contexts may be concurrently active (e.g., overlapping, simultaneous, etc.). In some embodiments, active vehicle contexts may be displayed via a tertiary display screen (e.g., a HUD display, dashboard display, etc.).

In some embodiments, context module 132 uses the vehicle systems data received via communications interface 150 to establish a “passenger” vehicle context. For example, one or more sensors (e.g., weight sensors, optical sensors, electromagnetic or capacitive sensors, etc.) may establish the presence of passengers in one or more of the passenger seats. In the “passenger” vehicle context, passenger application icons may be displayed on secondary display 164. Selecting a passenger application icon may activate a passenger display (e.g., on a rear surface of a driver's seat or front passenger seat, an overhead video display, a center console display, etc.) for presenting passenger-specific applications. Passenger-specific applications may include applications intended for use by vehicle occupants other than the driver. For example, passenger-specific applications may include video applications (e.g., DVD or BluRay playback), networking applications (e.g., web browsing, video communications, etc.), game applications, entertainment applications, or other applications intended for use by vehicle passengers. In some embodiments, context module 132 and or control system 106 may prevent a driver from accessing passenger-specific applications (e.g., a passenger must be present to access passenger-specific applications, passenger-specific applications are only displayed on passenger displays, etc.)

In some embodiments, context module 132 uses the data received via communications interface 150 to establish a vehicle location. For example, context module 132 may receive input data from a GPS satellite, a vehicle navigation system, or a portable navigation device to determine current GPS coordinates for vehicle 100. Context module 132 may compare the current GPS coordinates with map data or other location data (e.g., stored remotely or in local vehicle memory 130) to determine a current location of vehicle 100. The vehicle location may be an absolute location (e.g., coordinates, street information, etc.) or a vehicle location relative to a building, landmark, or other mobile system. For example, context module 132 may determine that vehicle 100 is approaching a user's home and/or garage when vehicle 100 enters a communications range with respect to an identified home control system or garage door control system. Context module 132 may determine a relative location of vehicle 100 (e.g., proximate to the user's home) and establish an “approaching home” vehicle context.

In some embodiments, context module 132 uses vehicle location data received via communications interface 150 to determine that vehicle 100 is approaching a designated restaurant, store, or other place of commerce and establish an “approaching business” vehicle context. In the “approaching business” vehicle context, one or more icons specific to the nearby business may be displayed (e.g., on secondary display 164). The icons may allow a user to contact the business, receive advertisements or other media from the business, view available products or services offered for sale by the business, and/or place an order with the business. For example, when context module 132 determines that vehicle 100 is approaching a restaurant designated as a “favorite restaurant,” icons may be displayed allowing the user to purchase a “favorite” meal or beverage sold by the restaurant. Selecting an icon may place an order with the business, authorize payment for the order, and/or perform other tasks associated with the commercial transaction.

In some embodiments, context module 132 determines that vehicle 100 is within communications range with respect to a remote system based on an absolute vehicle location (e.g., GPS coordinates, etc.) and a calculated distance between vehicle 100 and the remote system. For example, context module 132 may retrieve a maximum communications distance threshold (e.g., stored remotely or in local vehicle memory 130) specifying a maximum distance at which a direct communications link (e.g., radio transmission, cellular communication, WiFi connection, etc.) between vehicle 100 and the remote system may be established. Context module 132 may determine that vehicle 100 is within communications range with respect to the remote system when the distance between vehicle 100 and the remote system is less than the maximum communications distance threshold.

In other embodiments, context module 132 determines that vehicle 100 is within communications range with respect to a remote system when vehicle 100 receives a communication directly from the remote system. The communication may be a radio signal, a cellular signal, a WiFi signal, a Bluetooth® signal, or other wireless signal using any number of wireless communications protocols. In further embodiments, vehicle 100 may be within communications range with respect to a remote system regardless of vehicle location. For example, vehicle 100 may communicate with the remote system indirectly via a satellite link, cellular data link, or other permanent or semi-permanent communications channel.

In some embodiments, context module 132 uses vehicle location data received via communications interface 150 to determine that vehicle 100 is approaching a toll collection point (e.g., a toll booth, a toll checkpoint, etc.) and establish an “approaching toll” vehicle context. In the “approaching toll” vehicle context, toll information (e.g., icons, graphics, text, etc.) may be displayed on one or more user interface devices of vehicle 100 (e.g., primary display 162, secondary display 164, etc.). The toll-related information may inform a user of an amount of an upcoming toll, a remaining balance in an automated toll payment account associated with vehicle 100, or display other toll-related information (e.g., payment history, toll payment statistics, etc.). In some embodiments, the “approaching toll” vehicle context may cause one or more selectable icons to be displayed on secondary display 164. When selected, the icons may allow a user to automatically pay the upcoming toll, add funds to an automated toll payment account, obtain navigation instructions for avoiding the toll collection point, or perform other toll-related tasks.

In some embodiments, context module 132 uses vehicle location data received via communications interface 150 in conjunction with traffic information received from a local or remote data source to establish a “traffic condition” vehicle context. In the “traffic condition” vehicle context, information relating to traffic conditions in an area, street, highway, or anticipated travel path for vehicle 100 may be displayed on one or more user interface devices. In the “traffic condition” vehicle context, one or more traffic-related icons may be displayed on secondary display 164. The traffic-related icons may allow a user to obtain detailed traffic information (e.g., travel times, average speed, high-traffic routes, etc.), learn about a potential cause of any delay, and/or plan alternate travel paths (e.g. using an associated vehicle navigation system) to avoid an identified high-traffic route.

In some embodiments, context module 132 uses vehicle location data received via communications interface 150 in conjunction with weather data received from a local or remote data source to establish a “weather conditions” vehicle context. In the “weather conditions” vehicle context, one or more weather-related icons may be displayed on secondary display 164. Selecting a weather-related icon may cause weather information to be displayed on one or more user interface devices within vehicle 100. For example, a weather-related icon may cause temperature information, storm warnings, weather news, hazardous road conditions, or other important weather information to be displayed on primary display 162. Another weather-related icon may allow a user to view geographic weather maps or activate a navigation application to avoid routes having potentially hazardous road conditions.

In some embodiments, context module 132 uses the data received via communications interface 150 to establish a notification state. For example, context module 132 may receive input data from a mobile device such as a cell phone, tablet or portable media device. The input data may include text message data, voicemail data, email data, or other notification data. Context module 132 may establish a notification state for the mobile device based on the number, type, importance, and/or priority of the notifications. Context module 132 may also establish a notification state for remote system such as a home control system, a garage door control system, place of commerce, or any other remote system. For example, context module 132 may receive input data from a garage door control system indicating when the garage door was last operated and/or the current garage door state (e.g., open, closed, closing, etc.).

Still referring to FIG. 2, memory 130 is further shown to include a user interface (UI) configuration module 134. UI configuration module 134 may configure a user interface for one or more of user interface devices 160 (e.g., primary display 162, secondary display 164, the tertiary display, etc.).

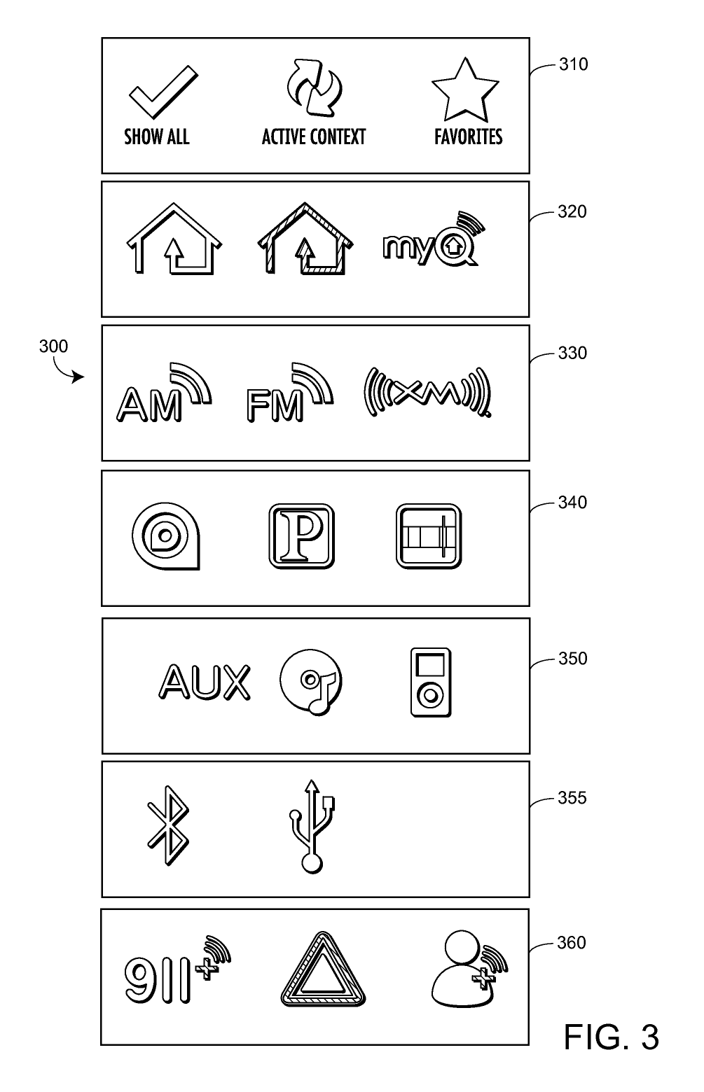

Referring now to FIG. 3, UI configuration module 134 may cause one or more selectable icons 300 to be displayed on secondary display 164. Selectable icons 300 are shown to include settings icons 310, home control icons 320, radio icons 330, application icons 340, audio device icons 350, 355, and emergency icons 360. UI configuration module 134 may cause any of icons 300 to be displayed on secondary display 164 either individually or in groups. In some embodiments, UI configuration module 134 may cause three of icons 300 to be displayed concurrently on secondary display 164.

In some embodiments, UI configuration module 134 may cause one or more of icons 300 to be displayed on a tertiary display. Advantageously, the tertiary display may indicate currently active vehicle contexts to a driver of the vehicle while allowing the driver to maintain focus on driving. For example, the tertiary display may indicate the context-specific icons 300 currently presented on secondary display 164 without requiring the driver to direct his or her gaze toward secondary display 164.

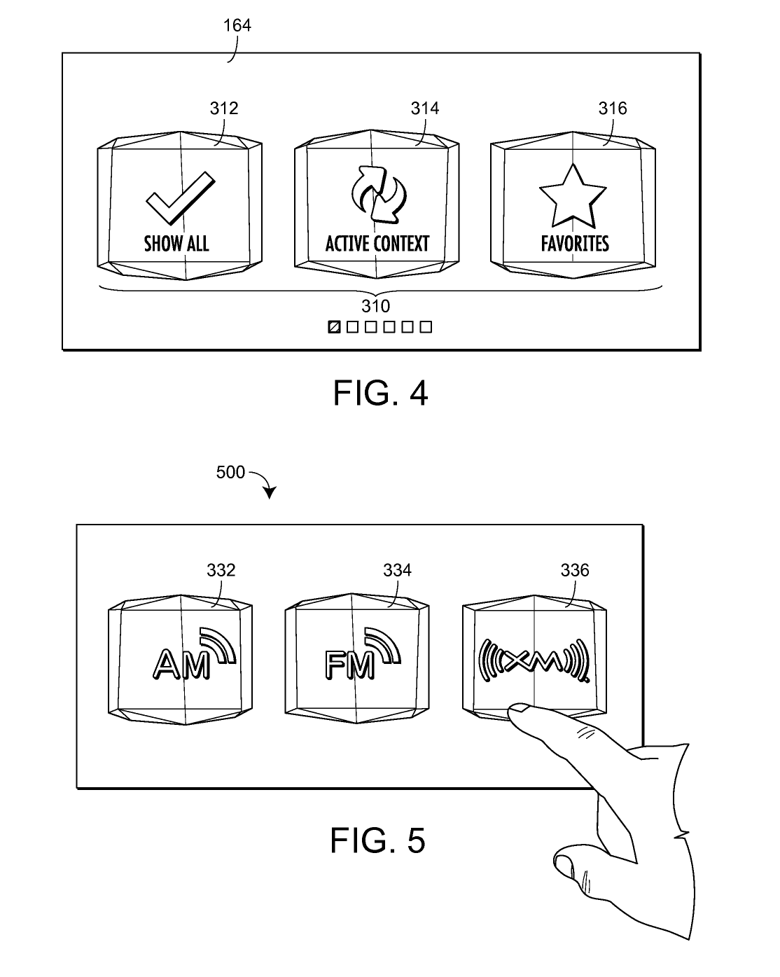

Referring to FIG. 4, secondary display 164 is shown displaying settings icons 310. Settings icons 310 are shown to include a “show all” icon 312, an “active context” icon 314, and a “favorites” icon 316. Settings icons 310 may provide a user with several options for controlling the display of icons 300 on secondary display 164. In some embodiments, activating (e.g., touching, clicking, selecting, etc.) “show all” icon 312 may instruct UI configuration module 134 to arrange all of icons 300 in a horizontal line and display a portion of the line (e.g., three icons) on secondary display 164. In an exemplary embodiment, a user may adjust the displayed icons (e.g., pan from left to right along the line) by swiping his or her finger across secondary display 164. In other embodiments, activating “show all” icon 312 may arrange icons 300 vertically, in a grid, or in any other configuration. A user may adjust the icons displayed on secondary display 164 via touch-based interaction (e.g., swiping a finger, touch-sensitive buttons, etc.), a control dial, knob, pushbuttons, or using any other tactile input mechanism.

In some embodiments, selecting “active context” icon 314 may instruct UI configuration module 134 to select icons for presentation on secondary display 164 based on a vehicle context, vehicle location, and/or notification state established by context module 132. Advantageously, UI configuration module 134 may actively reconfigure secondary display 164 to provide a user with appropriate icons for a given vehicle context, location, or notification state.

For example, UI configuration module 134 may receive an “approaching home” vehicle context from context module 132, indicating that vehicle 100 is within communications range of a home control system or garage door control system. UI configuration module 134 may cause home control icons 320 to be displayed on secondary display 164 in response to the “approaching home” vehicle context. UI configuration module 134 may receive a “cruising” vehicle context from context module 132, indicating that vehicle 100 is traveling at a steady speed. UI configuration module 134 may cause radio icons 330, application icons 340, or audio device icons 350 to be displayed on secondary display 134 in response to the “cruising” vehicle context. UI configuration module 134 may receive an “accident” vehicle context from context module 132, indicating that vehicle 100 has been involved in an accident. UI configuration module 134 may cause emergency icons 360 to be displayed on secondary display 164 in response to the “accident” vehicle context. UI configuration module 134 may receive a “distracted” vehicle context from context module 132, indicating that vehicle 100 is currently performing a maneuver (e.g., turning, reversing, changing lanes, etc.) that likely requires a driver's full attention. UI configuration module 134 may cause no icons (e.g., a blank screen) to be displayed on secondary display 164 in response to the “distracted” vehicle context.

In some embodiments, UI configuration module 134 may actively reconfigure a user interface for secondary display 164 based on a notification state of a remote system or mobile device. For example, UI configuration module 134 may receive a notification state for a cell phone, tablet, laptop, or other mobile device, indicating that the mobile device has one or more active notifications (e.g., text message notifications, email notifications, voicemail notifications, navigation notifications, etc.). UI configuration module 134 may cause an icon representing the mobile device to be displayed on secondary display 164 in response to the notification state. In some embodiments, the device icon may include a number, type, urgency, or other attribute of the active notifications. Selecting the device icon may provide a user with options for viewing the active notifications, playing voicemails (e.g., through a vehicle audio system), translating text based notifications to audio (e.g., via a text-to-speech device), displaying notification information on a tertiary screen, or replying to one or more notifications.

In some embodiments, UI configuration module 134 may reconfigure a user interface and/or primary display 132 based on an active vehicle context, location, or notification state. For example, UI configuration module 134 may receive a “low fuel” vehicle context from context module 132, indicating that vehicle 100 is low on fuel. UI configuration module 134 may cause primary display 162 to display a list of nearby fueling stations or navigation instructions toward the nearest fueling station. UI configuration module 134 may receive a notification state for a mobile device from context module 132, indicating that the mobile device is currently receiving a communication (e.g., text message, email, phone call, voice mail, etc.) UI configuration module 134 may cause an incoming text message, email, caller name, picture, phone number or other information to be displayed on primary display 132 in response to the mobile device notification. In further embodiments, UI configuration module 134 may reconfigure a tertiary display based on an active vehicle context. The tertiary display may be configured to display information relevant to an active vehicle context.

Still referring to FIG. 4, settings icons 310 are shown to include a “favorites” icon 316. Selecting “favorites” icon 316 may cause one or more favorite icons to be displayed on secondary display 164. Icons may be designated as favorite icons automatically (e.g., based on frequency of use, available control features, vehicle connectivity options, etc.) or manually via a user-controlled selection process.

Referring now to FIG. 5, an exemplary user interface 500 for displaying one or more favorite icons is shown, according to an exemplary embodiment. User interface 500 may be presented on secondary display 164 when “favorites” icon 316 is selected from settings icons 310. User interface 500 is shown to include an “AM” icon 332, an “FM” icon 334, and an “XM” icon 336. Icons 332, 334, 336 may be used to select AM, FM, or satellite radio stations (e.g., channels, frequencies, etc.) to play (e.g., tune, transmit, etc.) through an audio system of vehicle 100.

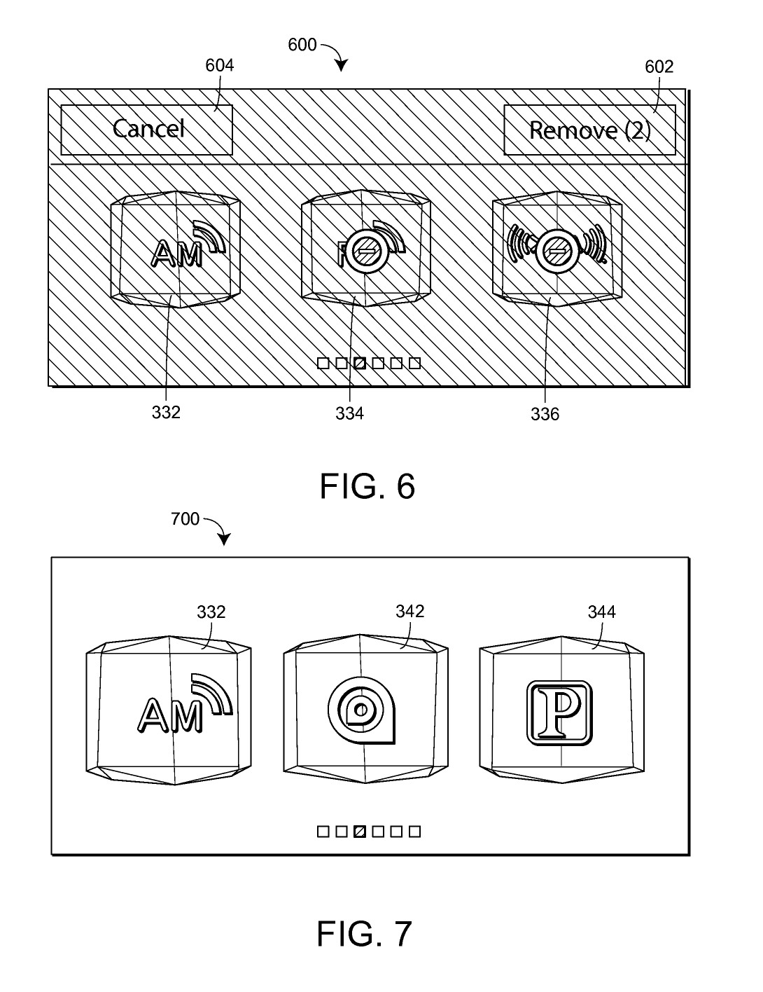

Referring now to FIG. 6, in some embodiments, UI configuration module 134 may provide a mechanism for a user to remove one or more icons from the group of favorite icons. For example, touching secondary display 164 and maintaining contact for a predefined period (e.g., an amount of time greater than a threshold value) may cause UI configuration module 134 to display a favorite icon removal interface 600. Interface 600 is shown to include the group of favorites icons (e.g., icons 332, 334, and 336), a “remove” icon 602, and a “cancel” icon 604. In some embodiments, selecting an icon displayed by interface 600 may cause the icon to be marked (e.g., with a subtraction symbol, a different color, size, or other marking) for removal. Selecting the same icon again may unmark the icon. Selecting “remove” icon 602 may cause any marked icons to be removed from the group of favorites. Selecting “cancel” icon 604 may return the user to a display of favorite icons (e.g., exit favorite icon removal interface 600). In some embodiments, selecting space not occupied by an icon on icon removal interface 600 causes UI configuration module 134 to exit favorite icon removal interface 600. In further embodiments, an exit icon may be used to exit favorite icon removal interface 600.

Referring to FIG. 7, user interface 700 displaying a modified group of favorite icons is shown, according to an exemplary embodiment. Interface 700 is shown to include “AM” icon 332 and audio application icons 342 and 344. Audio application icons 342 and 344 are shown having replaced “FM” icon 334 and “XM” icon 336 in the group of favorites. Audio application icons 342, 344 may be used to launch one or more audio applications (e.g., PANDORA®, STITCHER®, TUNE-IN®, etc.). Audio applications may include streaming audio applications, Internet-based audio applications, audio file management and playback applications, or other applications for controlling and/or playing auditory media.

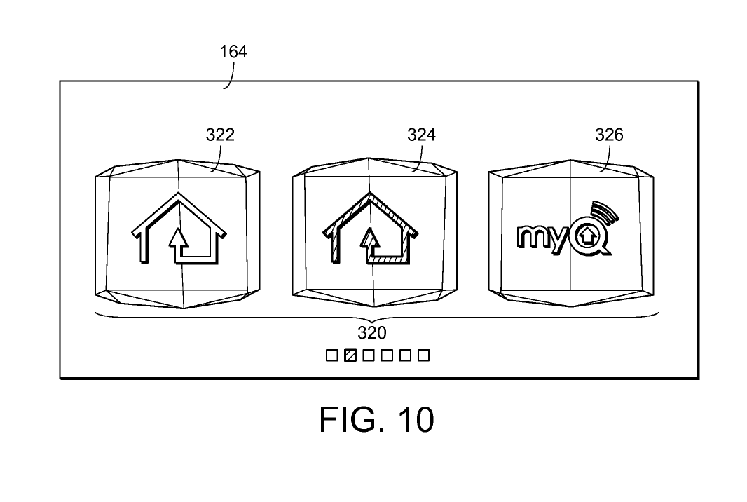

In some embodiments, audio application icons 342, 344 may be part of a group of application icons 340. Application icons 340 may be used (e.g., selected, activated, etc.) to launch various applications (e.g., audio applications, navigation applications, mobile commerce applications, home control applications, etc.). Application icons 340 may be presented on secondary display 164. In some embodiments, the applications launched via application icons 340 may be displayed on primary display 162. For example, selecting application icon 344 may cause the PANDORA® audio application to be displayed on primary display 162. Selecting a navigation icon may cause a navigation application to be displayed on primary display 162. Selecting a home control icon (e.g., icon 322 as shown in FIG. 10) may cause a home control application to be displayed on primary display 162. In some embodiments, application icons 340 and/or other application information may be displayed on a tertiary display.

In some embodiments, an application launched via an icon displayed on secondary display 164 may be presented (e.g., displayed, shown, etc.) exclusively on primary display 162. In some embodiments, an application launched via an icon displayed on secondary display 164 may be presented exclusively on a plurality of user interface devices other than secondary display 164. In some embodiments, application icons 340 may be displayed on secondary display 164 based on an active vehicle context, vehicle location, or device notification status. In other embodiments, application icons 340 may be displayed as favorite icons (e.g., automatically or non-automatically selected) by selecting “favorites” icon 316 or by scrolling through a list of icons after selecting “show all” icon 312.

Referring now to FIG. 8, an user interface 800 for adding icons to the group of favorite icons is shown, according to an exemplary embodiment. User interface 800 may be presented on secondary display 164 by selecting “show all” icon 312, subsequently touching secondary display 164, and maintaining contact for a predefined period (e.g., an amount of time greater than a threshold value. Interface 800 is shown to include “AM” icon 332, “FM” icon 334, “XM” icon 336, an “add to favorites” icon 802, and a “cancel” icon 804. In some embodiments, selecting an icon displayed by interface 800 may cause the icon to be marked (e.g., with an addition symbol, a different color, size, or other marking) for addition. Selecting a marked icon may unmark the icon. Selecting “add to favorites” icon 802 may cause any marked icons to be added from the group of favorites. Selecting “cancel” icon 804 may return the user to a display of favorite icons (e.g., exit user interface 800). In other embodiments, the user may be returned to a list of all icons. In some embodiments, selecting space not occupied by an icon on user interface interface 800 causes UI configuration module 134 to exit user interface 800. In further embodiments, an exit icon may be used to exit user interface 800.

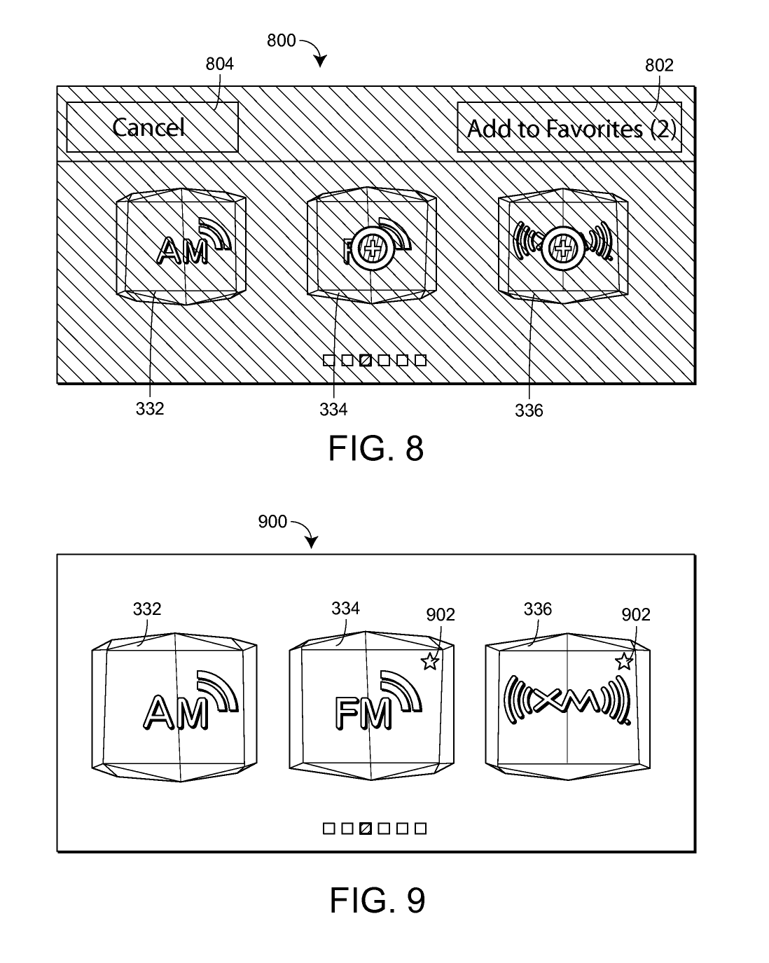

Referring now to FIG. 9, an exemplary user interface 900 is shown. User interface 900 may be displayed on secondary display 164 after adding one or more icons to the group of favorites via user interface 800. User interface 900 is shown to include radio icons 330 (e.g., icons 332, 334, and 336). Interface 900 is further shown to include a favorites marking 902. Marking 902 may be a symbol, color, size, orientation, highlighting, or other effect applied to one or more of icons. Marking 902 may indicate that the marked icon is a member of the group of favorite icons. In some embodiments, marking 902 may not be displayed when viewing icons through interface 500 (e.g., after selecting “favorites” icon 316.)

Referring now to FIG. 10, UI configuration module 134 may cause secondary display 164 to display home control icons 320. In some embodiments, home control icons 320 may be displayed based on an active context, location, or notification state as determined by context module 132. For example, home control icons 320 may be displayed when the “approaching home” vehicle context is active. Advantageously, the context-based display of icons may provide a user with immediate access to appropriate applications, information (e.g., remote system status, etc.), and control actions (e.g., opening and closing a garage door, turning on/off home lights, etc.) based on the active context of vehicle 100. In other embodiments, icons 320 may be displayed as part of a group of favorite icons (e.g., after selecting “favorites” icon 316), or as a subset of all icons 300 (e.g., after selecting “show all” icon 312).

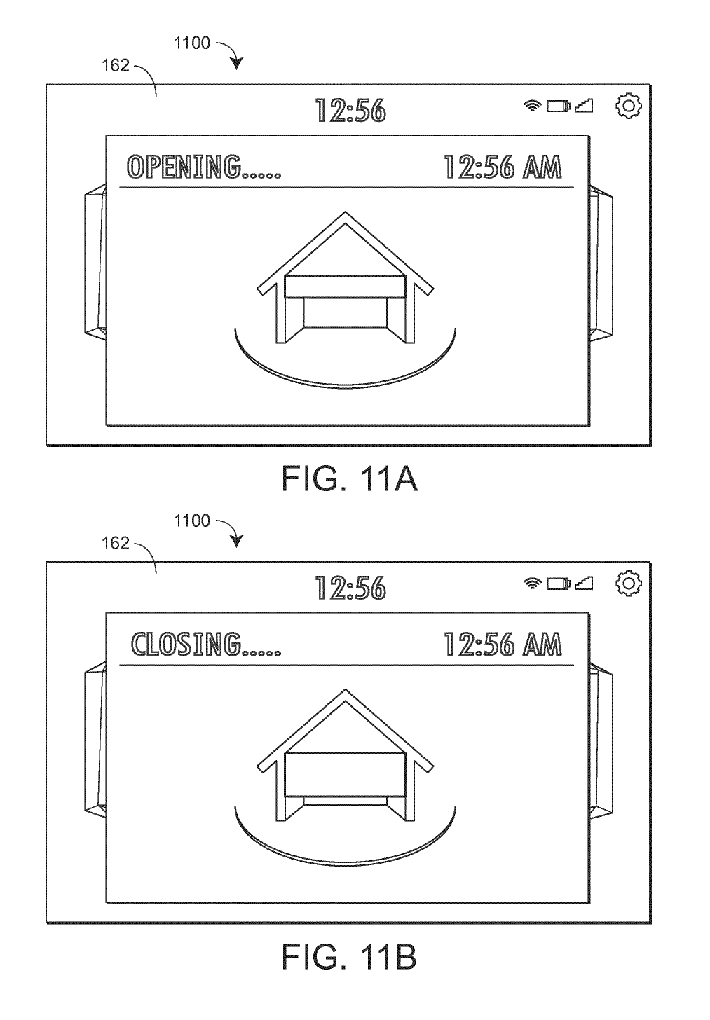

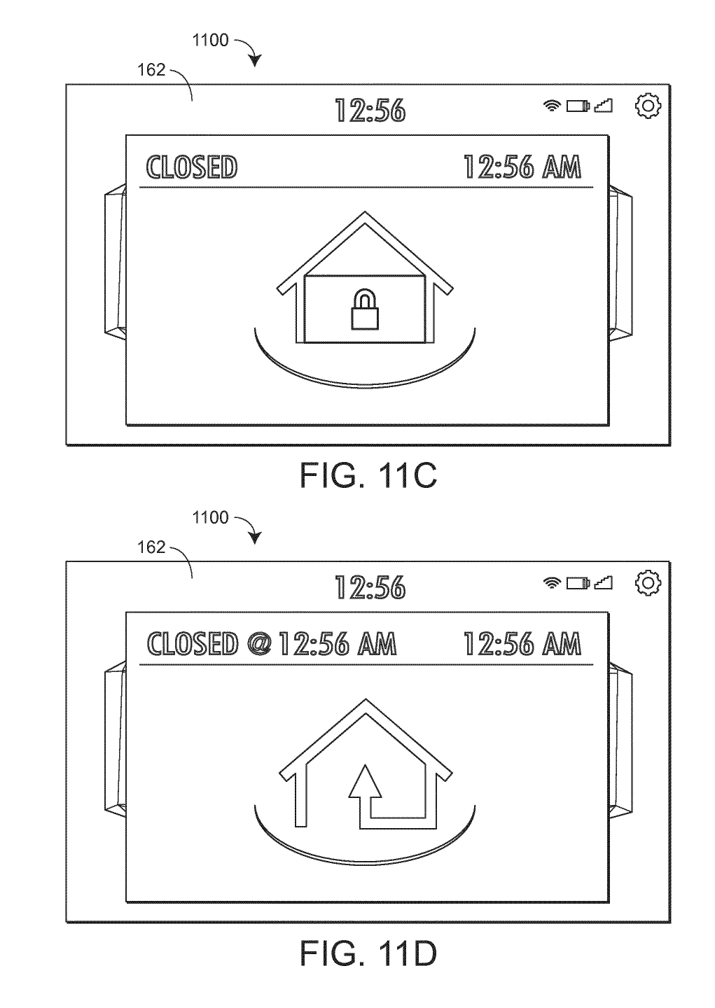

Home control icons 320 are shown to include a garage door control icon 322, an untrained icon 324, and a “MyQ” icon 326. Garage door control icon 322 may allow a user to interact with a remote garage door control system. For example, icon 322 may allow a user to open and/or close a garage door, view information regarding whether the garage door is currently open, closed, opening, or closing, and/or view timing information regarding when the garage door was last operated. This information may be displayed on one or more of primary display 162, secondary display 164, and a tertiary display as described in greater detail in reference to FIG. 11.

Untrained icon 324 may serve as a placeholder for other home control icons not currently associated (e.g., linked, trained, configured, etc.) with a remote home control system. Selecting untrained icon 324 cause training instructions to be displayed on primary display 162. The training instructions may be textual, verbal, (e.g., audio recordings, text-to-speech, etc.), audio-visual (e.g., video files, streaming media, etc.) or any combination thereof. Training instructions may be retrieved from local memory 130 within vehicle 100, from a remote system, a mobile device, or any other source.

MyQ icon 326 may allow user interaction with a remote home control system such as a lighting system, a temperature system, a security system, an HVAC system, a home networking system, home data system, or any other system capable of communicating with control system 106. In some embodiments, selecting MyQ icon 326 may launch a home control application displayed on primary display 162. In other embodiments, selecting MyQ icon 326 may display a subset of home control icons (e.g., a home lighting icon, a home security icon, etc.) on secondary display 162. Home control icons 320 may allow a user to view the status of a home control system (e.g., whether lights are on, whether security is active, whether a garage door is open or closed, etc.) via a user interface presented on at least one of primary display 162 and secondary display 164.

Referring now to FIGS. 11A-11D, an exemplary user interface 100 presented on primary display 162 is shown. UI configuration module 134 may cause primary display 162 to present one or more applications, notifications, user interfaces, information, or other visual displays. In some embodiments, selecting one of icons 300 via secondary display 164 may launch an application presented visually on primary display 162. The launched application may be presented visually exclusively on primary display 162. In some embodiments, the launched application may be presented visually on one or more user interface devices other than secondary display 164. In other embodiments, the launched application is presented on both primary display 162 and secondary display 164. Applications presented on primary display 162 may include home control applications (e.g., lighting, security, garage door, etc.), radio applications (e.g., FM radio, AM radio, satellite radio, etc.), audio applications, (e.g., PANDORA®, STITCHER®, TUNE-IN®, etc.), navigation applications, communications applications, mobile commerce applications, emergency applications, or any other type of application including a visual display.

Referring specifically to FIG. 11A, selecting garage door control icon 322 via secondary display 164 may communicate a control action to a remote garage door control system via remote systems interface 154, thereby causing the garage door to open. UI configuration module 134 may cause a computer graphic, animation, video, or other visual information to be displayed on primary display 162 showing that the garage door is currently opening. The information may be displayed on primary display 162 upon receiving a communication from the garage door control system that the garage door is currently opening or upon sending the control action to the remote system.

In some embodiments, control system 106 establishes a communications link with the remote garage door control system upon entering a communications range with respect to the remote system (e.g., prior to initiating the control action). In some embodiments, UI configuration module 134 may not display garage door control icon 322 unless a communications link has been established with the garage door control system. Control system 106 may receive information specifying a current state of the garage door (e.g., open, closed, etc.) and timing information specifying when the garage door was last operated.

Referring to FIG. 11B, selecting garage door control icon 322 via secondary display 164 when the garage door is open may communicate a control action to the remote garage door control system, thereby causing the garage door to close. UI configuration module 164 may cause a computer graphic, animation, video, or other visual information to be displayed on primary display 162 showing that the garage door is currently closing.

Referring to FIGS. 11C and 11D, UI configuration module 134 may cause primary display to display an icon, computer graphic, video, or other information indicating that the garage door is closed. The information may be displayed on primary display 162 upon receiving a communication from the garage door control system that the garage door has successfully closed or upon sending the control action to the remote system.

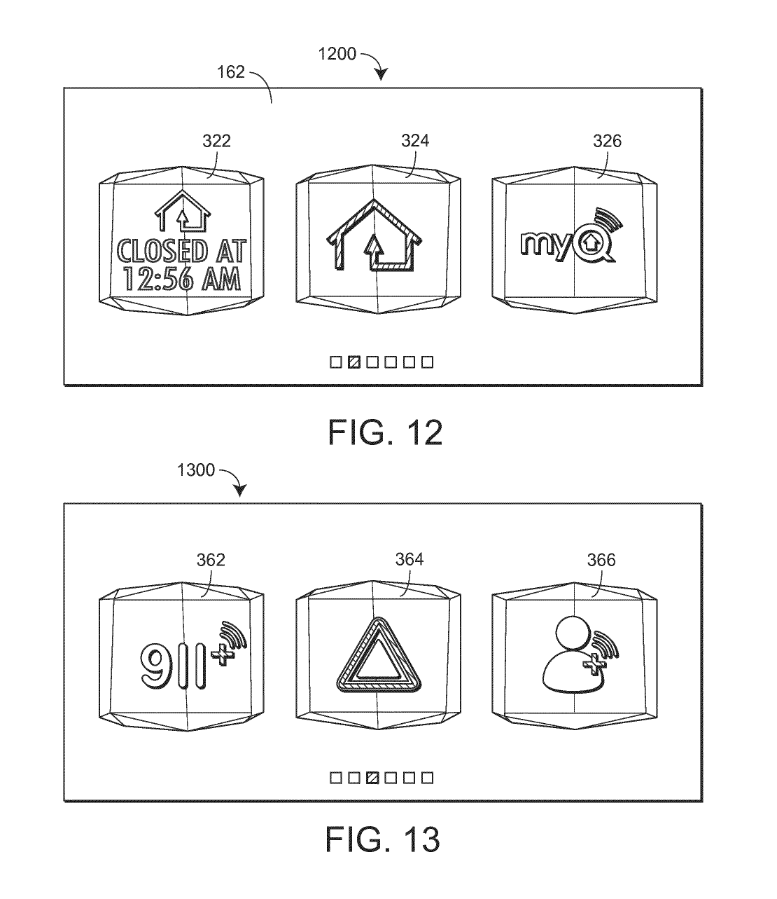

Referring now to FIG. 12, UI configuration module 134 may cause secondary display 164 to include information relating to a current state of the garage door (e.g., whether the garage door is open, closed, opening, closing, obstructed, non-responsive, etc.) and/or timing information regarding when the transition to the current state occurred (e.g., when the door was closed, etc.). The state information and timing information may be displayed within garage door control icon 322.

Referring to FIG. 13, UI configuration module 134 may cause secondary display 164 to display an emergency user interface 1300. Interface 1300 is shown to include a “911” icon 362, a hazard icon 364, and an insurance icon 366 (e.g., emergency icons 360). In some embodiments, emergency icons 360 may be displayed based on an active context, location, or notification state as determined by context module 132. For example, emergency icons 360 may be displayed when the “accident” vehicle context is active, indicating that vehicle 100 has been involved in an accident or collision. Advantageously, the context-based display of icons may provide a user with immediate access to appropriate applications, information (e.g., insurance information, emergency contact information, etc.), and control actions (e.g., calling 911, activating hazard lights, etc.) based on the active context of vehicle 100. In other embodiments, icons 360 may be displayed as part of a group of favorite icons (e.g., after selecting “favorites” icon 316), or as a subset of all icons 300 (e.g., after selecting “show all” icon 312).

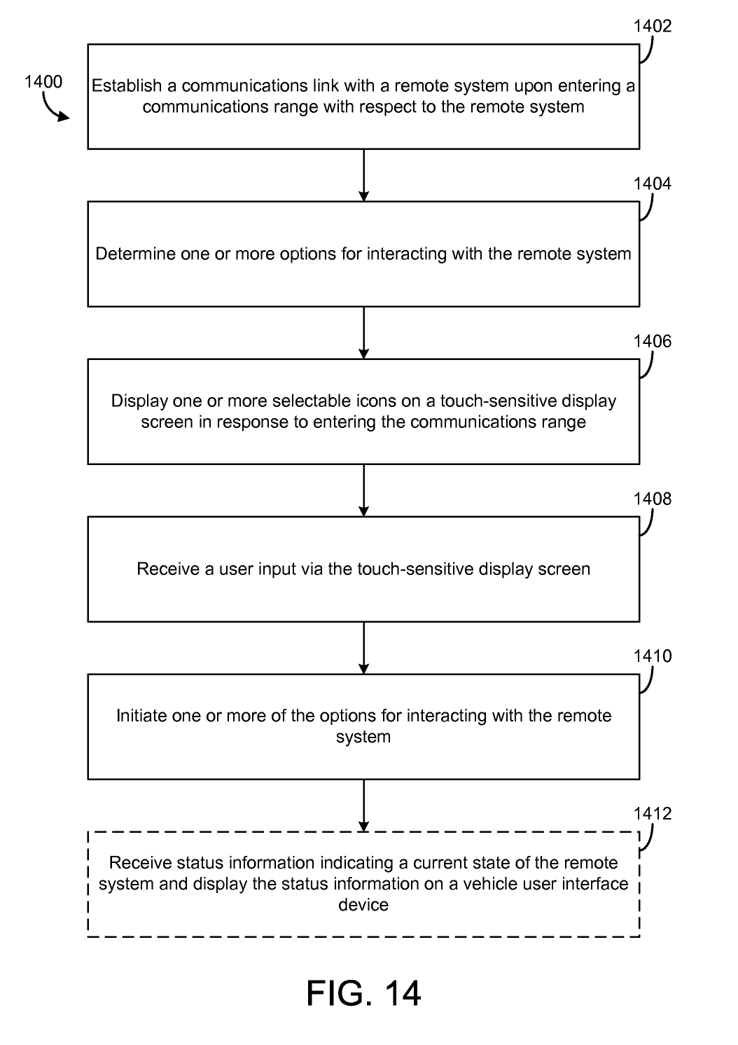

Referring to FIG. 14, a flowchart of a process 1400 for dynamically reconfiguring a user interface presented on one or more display screens in a vehicle is shown, according to an exemplary embodiment. Process 1400 is shown to include establishing a communications link with a remote system upon entering a communications range with respect to the remote system (step 1402). Step 1402 may be performed after driving, transporting, or otherwise moving vehicle 100 within communications range of a remote system. The remote system may be any system or device external to vehicle 100 capable of interacting with control system 106 via remote systems interface 154. Remote systems may include a radio tower, a GPS navigation or other satellite, a cellular communications tower, a wireless router (e.g., WiFi, IEEE 802.11, IEEE 802.15, etc.), a BLUETOOTH® capable remote device, a home control system, a garage door control system, a remote computer system or server in communication with a restaurant, business, place of commerce, or any other remote system capable of communicating wirelessly via remote systems interface 154. Vehicle 100 may enter a communications range with respect to the remote system when a data signal of sufficient strength to facilitate communication between control system 106 and the remote system may be exchanged (e.g., wirelessly via remote systems interface 154).

Process 1400 is further shown to include determining one or more options for interacting with the remote system (step 1404). Options for interacting with the remote system may include control actions (e.g., sending or receiving a control signal), information display options (e.g., receiving a status of the remote system), messaging options (e.g., receiving a commerce-related message or advertisement from the remote system), communications options (e.g., placing an order, exchanging consumer or payment information, wireless networking, etc.) or any combination thereof.

Process 1400 is further shown to include displaying one or more selectable icons on a touch-sensitive display screen in response to entering the communications range (step 1406). Advantageously, the user interface presented on the touch-sensitive display screen may be reconfigured to present selectable icons corresponding to the options for interacting with the remote system. Selecting one of the displayed icons may initiate a control action, request information, send or receive a message, or otherwise communicate with the remote system. The icons may replace or supplement icons previously displayed on the display screen prior to establishing the communications link with the remote system.

Process 1400 is further shown to include receiving a user input via the touch-sensitive display screen (step 1408) and initiating one or more of the options for interacting with the remote system (step 1410). In some embodiments, a user input is received when a user touches a portion of the display screen. A user may touch a portion of the screen displaying an icon to select the displayed icon. Selecting an icon may initiate an option for interacting with the remote system associated with the selected icon. For example, touching a garage door control icon may send a control signal to a remote garage door control system instructing the remote system to open or close the garage door.

In some embodiments, process 1400 further includes receiving status information indicating a current state of the remote system and displaying the status information on a vehicle user interface device (step 1412). Step 1412 may involve receiving a communication from the remote system indicating a current state of a garage door (e.g., open, closed, closing, etc.), a security system (e.g., armed, disarmed, etc.), or a lighting system (e.g., lights on, lights off, etc.), as well as timing information indicating at what time the remote system transitioned to the current state. Step 1412 may further involve displaying the status information and/or timing information on a user interface device within vehicle 100 (e.g., primary display 162, secondary display 164, etc.).

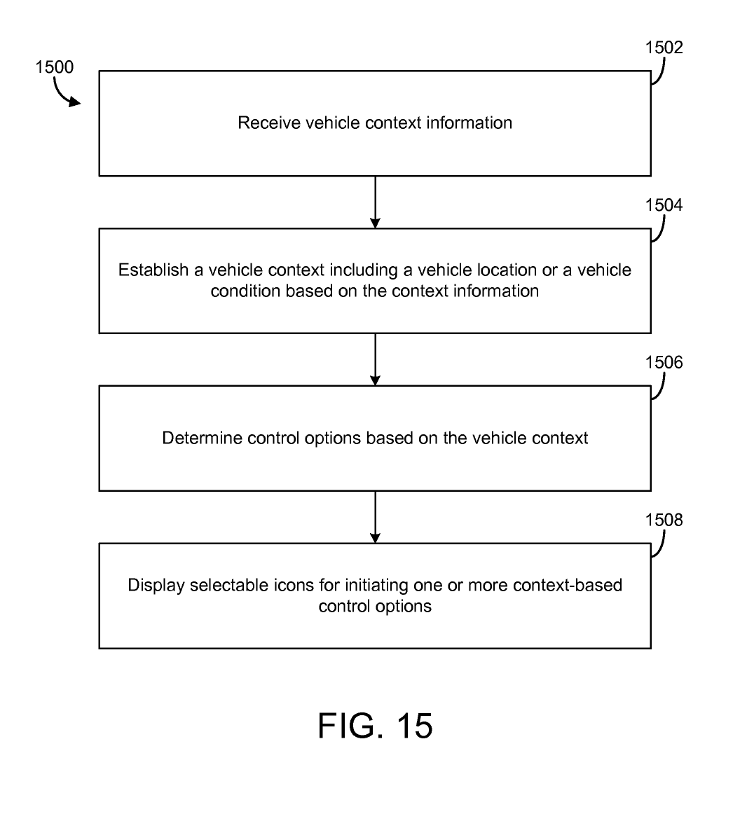

Referring now to FIG. 15, a flowchart illustrating a process 1500 for contextually reconfiguring a user interface presented on one or more display screens in a vehicle is shown, according to an exemplary embodiment. Process 1500 is shown to include receiving vehicle context information (step 1502). Vehicle context information may be received from one or more vehicle systems (e.g., a navigation system, an engine control system, a transmission control system, a fuel system, a timing system, an anti-lock braking system, a speed control system, etc.) via vehicle systems interface 152. Context information may include measurements from one or more local vehicle sensors (e.g., a fuel level sensor, a braking sensor, a steering or turning sensor, etc.) as well as information received by a local vehicle system from a mobile device or remote system. Context information may also be received directly from one or more remote systems via remote systems interface 154 and from one or more mobile devices via mobile devices interface 156. Context information received from a remote system may include GPS coordinates, mobile commerce data, interactivity data from a home control system, traffic data, proximity data, location data, etc. Context information received from a mobile device may include text, numeric data, audio, video, program data, command data, information data, coordinate data, image data, streaming media, or any combination thereof.

Process 1500 is further shown to include establishing a vehicle context including a vehicle location or a vehicle condition based on the context information (step 1504). For example information received from a vehicle fuel system indicating an amount of fuel remaining in vehicle 100 may be used to establish a “low fuel” vehicle context. Information received from an accident detection system indicating that vehicle 100 has been involved in a collision may be used to establish an “accident” vehicle context. Information received from a speed control or speed monitoring system indicating a current speed of vehicle 100 may be used to establish a “cruising” vehicle context. Information received from a vehicle system indicating that vehicle 100 is currently turning or that the driver is otherwise busy may be used to establish a “distracted” vehicle context.

In some embodiments, step 1504 involves using the context information to establish a vehicle location. For example, information received from a GPS satellite, a vehicle navigation system, or a portable navigation device to determine current GPS coordinates for vehicle 100. Step 1504 may involve comparing the current GPS coordinates with map data or other location data (e.g., stored remotely or in local vehicle memory 130) to determine a current location of vehicle 100. The vehicle location may be an absolute location (e.g., coordinates, street information, etc.) or a vehicle location relative to a building, landmark, or other mobile system.

In some embodiments, step 1504 involves determining that vehicle 100 is approaching a user's home and/or garage when vehicle 100 enters a communications range with respect to an identified home control system or garage door control system. The context information may be used to determine a relative location of vehicle 100 (e.g., proximate to the user's home) and establish an “approaching home” vehicle context. In other embodiments, step 1504 may involve determining that vehicle 100 is nearby a restaurant, store, or other place of commerce and establishing an “approaching business” vehicle context.

Process 1500 is further shown to include determining control options based on the vehicle context (step 1506) and displaying selectable icons for initiating one or more of the context-based control options (step 1508). For example, the “approaching home” vehicle context may indicate that vehicle 100 is within communications range of a home control system or garage door control system. Step 1508 may involve displaying the home control icons 320 on secondary display 134 in response to the “approaching home” vehicle context. In some embodiments, the “cruising” vehicle context may indicate that vehicle 100 is traveling at a steady speed. Step 1508 may involve displaying radio icons 330, application icons 340, or audio device icons on secondary display 134 in response to the “cruising” vehicle context. In some embodiments, the “accident” vehicle context may indicate that vehicle 100 has been involved in an accident. Step 1508 may involve displaying emergency icons 360 on secondary display 164 in response to the “accident” vehicle context. In some embodiments, the “distracted” vehicle context may indicate that vehicle 100 is currently performing a maneuver (e.g., turning, reversing, changing lanes, etc.) that likely requires a driver's full attention. Step 1508 may involve displaying no icons (e.g., a blank screen) on secondary display 164 in response to the “distracted” vehicle context.

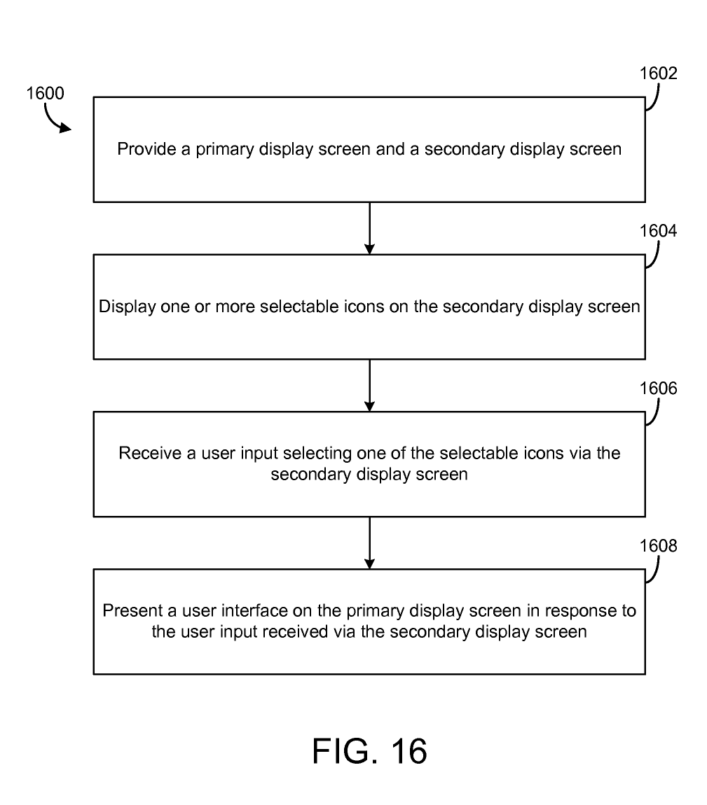

Referring now to FIG. 16, a process 1600 for configuring a user interface presented on a primary display screen based on input received via a secondary display screen is shown, according to an exemplary embodiment. Process 1600 is shown to include providing a primary display screen and a secondary display screen (step 1602). In some embodiments, the primary display screen is a touch-sensitive display whereas in other embodiments, the primary display screen is a non-touch-sensitive display. The primary display screen may include one or more knobs, pushbuttons, and/or tactile user inputs. The primary display screen may be of any technology (e.g., liquid crystal display (LCD), plasma, thin film transistor (TFT), cathode ray tube (CRT), etc.), configuration (e.g., portrait or landscape), or shape (e.g., polygonal, curved, curvilinear). The primary display screen may be a manufacturer installed output display, an aftermarket output display, or an output display from any source. The primary display screen may be an embedded display (e.g., a display embedded in control system 106 or other vehicle systems, parts or structures), a standalone display (e.g., a portable display, a display mounted on a movable arm), or a display having any other configuration.

In some embodiments, the secondary display screen is a touch-sensitive user input device (e.g., capacitive touch, projected capacitive, piezoelectric, etc.) capable of detecting touch-based user input. The secondary display screen may be of any technology (e.g., LCD, plasma, CRT, TFT, etc.), configuration, or shape. The secondary display screen may be sized to display several (e.g., two, three, four or more, etc.) selectable icons simultaneously. For embodiments in which the secondary display is a touch-sensitive display, an icon may be selected by touching the icon. Alternatively, the secondary display screen may be a non-touch-sensitive display including one or more pushbuttons and/or tactile user inputs for selecting a displayed icon.

Process 1600 is further shown to include displaying one or more selectable icons on the secondary display screen (step 1604). In some embodiments, the icons may be displayed based on an active vehicle context, location, or notification state. For example, home control icons 320 may be displayed when the “approaching home” vehicle context is active. Advantageously, the context-based display of icons may provide a user with immediate access to appropriate applications, information (e.g., remote system status, etc.), and control actions (e.g., opening and closing a garage door, turning on/off home lights, etc.) based on the active context of the vehicle. In other embodiments, the icons may be displayed as part of a group of favorite icons (e.g., after selecting “favorites” icon 316), or as a subset of all icons 300 (e.g., after selecting “show all” icon 312).

Process 1600 is further shown to include receiving a user input selecting one of the selectable icons via the secondary display screen (step 1606) and presenting a user interface on the primary display screen in response to the user input received via the secondary display screen (step 1608). For embodiments in which the secondary display screen is a touch-sensitive display, a user input is received when a user touches a portion of the secondary display screen. For example, a user may touch a portion of the screen displaying an icon to select the displayed icon.

In some embodiments, step 1608 may involve presenting one or more applications, notifications, user interfaces, information, or other visual displays on the primary display screen. For example, selecting an icon displayed on the secondary display screen may launch an application presented visually on the primary display screen. The launched application may be presented visually exclusively on the primary display screen. In some embodiments, the launched application may be presented visually on one or more user interface devices other than the secondary display screen. In other embodiments, the launched application is presented on both the primary display screen and the secondary display screen. Applications presented on the primary display screen may include home control applications (e.g., lighting, security, garage door, etc.), radio applications (e.g., FM radio, AM radio, satellite radio, etc.), audio applications, (e.g., PANDORA®, STITCHER®, TUNE-IN®, etc.), navigation applications, communications applications, mobile commerce applications, emergency applications, or any other type of application including a visual display.

The construction and arrangement of the elements of user interface control system 106 as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. The elements and assemblies may be constructed from any of a wide variety of materials that provide sufficient strength or durability, in any of a wide variety of colors, textures, and combinations. Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for contextually reconfiguring a user interface in a vehicle, the method comprising:
establishing a communications link with a remote system, wherein the communications link is established when the vehicle enters a communications range with respect to the remote system;
determining one or more options for interacting with the remote system; and
displaying one or more selectable icons on a touch-sensitive display screen in response to the vehicle entering the communications range, wherein selecting an icon initiates one or more of the options for interacting with the remote system.

2. The method of claim 1, wherein the remote system is a home control system including at least one of a garage door system, a gate control system, a lighting system, a security system, and a temperature control system, wherein the options for interacting with the remote system are options for controlling the home control system.

3. The method of claim 1, further comprising:
receiving status information from the remote system, wherein the status information includes information relating to a current state of the remote system; and
causing the user interface to display the status information in conjunction with the one or more of the selectable icons.

4. A method for contextually reconfiguring a user interface in a vehicle, the method comprising:
receiving context information for the vehicle;
determining a vehicle context based on the context information, wherein the vehicle context includes at least one of a location of the vehicle and a condition of the vehicle;
determining one or more control options based on the vehicle context; and
causing the user interface to display one or more selectable icons, wherein the icons are displayed in response to the determined vehicle context and wherein selecting an icon initiates one or more of the context-based control options.

5. The method of claim 4, wherein the vehicle includes a primary display screen and a secondary display screen, wherein only the selectable icons are displayed on the secondary display screen.

6. The method of claim 4, wherein the vehicle context is a location of the vehicle, the method further comprising:
determining that the vehicle is within a communications range with respect to a remote system based on the location of the vehicle; and
establishing a communications link with the remote system.

7. The method of claim 4, wherein the vehicle context is a condition of the vehicle, wherein the condition is at least one of a low fuel indication, an accident indication, a vehicle speed indication, and a vehicle activity indication.

8. A system for providing a user interface in a vehicle, the system comprising:
a primary display screen;
a secondary display screen; and
a processing circuit coupled to the primary and secondary display screens,
wherein the secondary display screen is a touch-sensitive display and wherein the processing circuit is configured to receive user input via the secondary display screen and to present a user interface on the primary display screen in response to the user input received via the secondary display screen.

9. The system of claim 8, wherein the processing circuit is configured to cause one or more selectable icons to be displayed on the secondary display screen, wherein the user input received via the secondary display screen includes selecting one of more of the icons.

10. The system of claim 9, wherein only the selectable icons are displayed on the secondary display screen.

11. The system of claim 8, wherein the user input received via the secondary display screen launches an application, wherein a user interface for the application is presented on the primary display screen.

12. The system of claim 8, wherein the user input received via the secondary display screen launches an application, wherein a user interface for interacting with the launched application is presented exclusively on one or more user interface devices other than the secondary display screen.

13. A method for providing a user interface in a vehicle, the method comprising:
providing a primary display screen and a secondary display screen, wherein the secondary display screen is a touch-sensitive display;
displaying one or more selectable icons on the secondary display screen;
receiving a user input via the secondary display screen, wherein the user input includes a selection of one or more of the selectable icons; and
presenting a user interface on the primary display screen in response to the user input received via the secondary display screen.

14. The method of claim 13, wherein the user input received via the secondary display screen launches an application, wherein a user interface for interacting with the launched application is presented exclusively on one or more user interface devices other than the secondary display screen.

15. A system for providing a user interface in a vehicle, the system comprising:
a touch-sensitive display screen;
a mobile device interface; and
a processing circuit coupled to the touch-sensitive display screen and the mobile device interface,
wherein the processing circuit is configured to receive a user input via the touch-sensitive display screen and to launch an application on a mobile device connected via the mobile device interface in response to the user input.
